(19) United States
(12) Patent Application Publication
(10) Pub. No.: US 2013/0222349 A1
(43) Pub. Date: Aug. 29, 2013

(54) CREDIT CARD WITH FLEXIBLE DISPLAY

(71) Applicants: Ji-Yeon Baek, Yongin-si (KR); Yong-Geon Kim, Busan (KR)

(72) Inventors: Ji-Yeon Baek, Yongin-si (KR); Yong-Geon Kim, Busan (KR)

(21) Appl. No.: 13/617,545

(22) Filed: Sep. 14, 2012

(30) Foreign Application Priority Data
Feb. 27, 2012 (KR) 20-2012-0001494

(51) Int. Cl. G06F 3/038

(52) U.S. Cl. 345/204

(57) ABSTRACT

A credit card includes a transparent flexible display panel for displaying an image, a frame supporting at least one end of the transparent flexible display panel, a driver coupled to the frame and configured to bend the transparent flexible display panel, and a controller coupled to the driver for driving the driver upon an occurrence of a condition, wherein the credit card is configured to enable a payment function.

### CROSS-REFERENCE TO RELATED APPLICATION

This application claims priority to and the benefit of Korean Patent Application No. 20-2012-0001494 filed in the Korean Intellectual Property Office on Feb. 27, 2012, the entire contents of which are incorporated herein by reference.

### BACKGROUND

(a) Field

Embodiments of the present invention relate to a credit card.

(b) Description of the Related Art

A credit card is a card used for electronic payment. These days, a credit card equipped with a display for displaying images has drawn much attention.

In the related art, a credit card including a display can be used to make a payment, and can also display information, so that a user using the credit card can see how much has been spent using the credit card for a given time frame (e.g., in a billing cycle, or in a month) when the user checks payment information.

The above information disclosed in this Background section is only for enhancement of understanding of the background of the embodiments of the invention, and therefore may contain information that does not form the prior art that is already known in this country to a person of ordinary skill in the art.

### SUMMARY

Embodiments of the present invention provide a credit card enabling passive viewing of payment information by a user.

An exemplary embodiment of the present invention provides a credit card including a transparent flexible display panel for displaying an image, a frame supporting at least one end of the transparent flexible display panel, a driver coupled to the frame and configured to bend the transparent flexible display panel, and a controller coupled to the driver for driving the driver upon an occurrence of a condition, wherein the credit card is configured to enable a payment function.

The transparent flexible display panel may include an organic light emitting element.

The transparent flexible display panel may include a fingerprint recognition sensor for analyzing a fingerprint.

The payment function might be enabled only for a period of time after the fingerprint recognition sensor recognizes the fingerprint as authorized.

The frame may include a light emitting part for emitting light of various colors.

The frame may include a support for enabling the credit card to be freestanding.

The driver may be mounted on a portion of the frame and may be configured to bend the transparent flexible display panel so that an end side of the transparent flexible display panel is bent in a “U” shape.

The occurrence of the condition may be when a payment amount exceeds a limit.

The payment function may use a near field communication (NFC).

The credit card may further include bimetal coupled to a plurality of conductive materials having different thermal expansion coefficients to enable the driver to bend the transparent flexible display panel.

Accordingly, exemplary embodiments of the present invention provide a credit card where a user can passively check payment information.

### BRIEF DESCRIPTION OF THE DRAWINGS

FIG. 1 is a diagram illustrating a credit card according to an exemplary embodiment of the present invention.

FIG. 2 is a diagram illustrating a back side of the credit card according to the exemplary embodiment of the present invention shown in FIG. 1.

FIG. 3 is a diagram illustrating the credit card according to the exemplary embodiment of the present invention shown in FIG. 1, and shown in a bent state.

### DETAILED DESCRIPTION

Embodiments of the present invention will be described more fully hereinafter with reference to the accompanying drawings, in which the exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification. In addition, the size and thickness of each component in the drawings may be arbitrarily shown for understanding and ease of description, but the present invention is not limited thereto. Further, in the drawings, the thickness of layers, films, panels, regions, etc., may be exaggerated for clarity and/or for the sake of convenience for description of the drawings.

In addition, unless explicitly described to the contrary, the word “comprise” and variations such as “comprises” or “comprising”, will be understood to imply the inclusion of stated elements but not the exclusion of any other elements

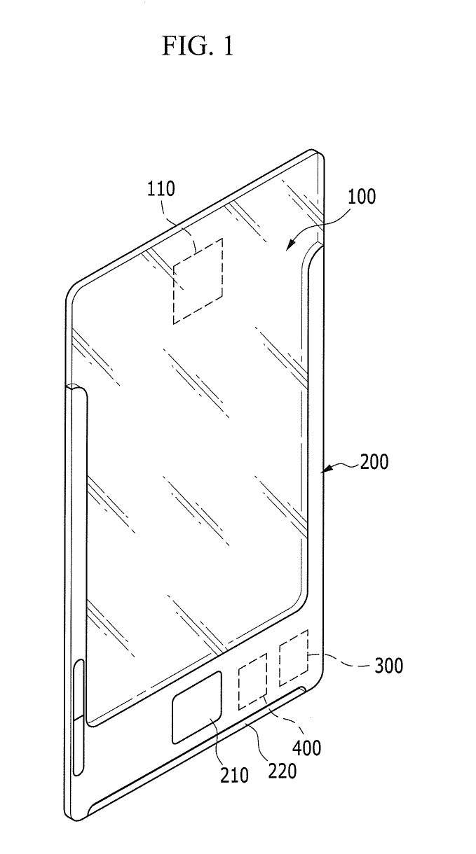

Hereinafter, referring to FIGS. 1 to 3, a credit card according to an exemplary embodiment of the present invention will be described.

FIG. 1 is a diagram illustrating a credit card according to an exemplary embodiment of the present invention.

As shown in FIG. 1, the credit card according to the present embodiment includes a transparent flexible display panel 100, a frame 200, a driver 300, and a controller 400.

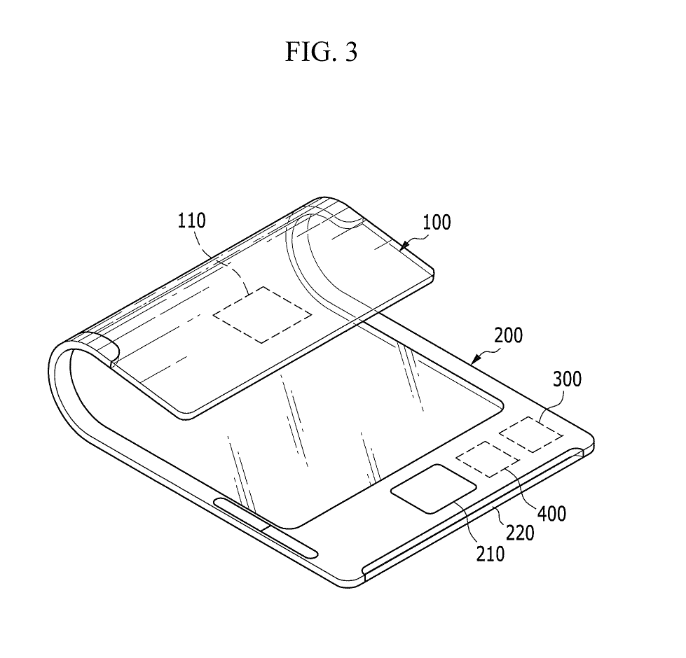

The transparent flexible display panel 100 displays images (e.g., images in connection with functions performed in the credit card). For example, if the credit card has, in addition to a payment function, a call function, a multimedia driving function, and the like, it is possible to display a user interface (UI) or graphic user interface (GUI) in connection with these functions (e.g., video or other multimedia) while displaying the form of the multimedia. The transparent flexible display panel 100 may include flexible substrates or films, and the like, which may be bent in a “U” shape (see FIG. 3), the flexible substrates or films may have a liquid crystal, an organic light emitting diode, and/or the like interposed therebetween. The transparent flexible display panel 100 may be transparent or light transmissive. On the top side of the transparent flexible display panel 100 of the present embodiment, there may be a touch sensor, which senses touch operations (e.g., a touch film, a touch sheet, a touch pad, and the like). The transparent flexible display panel 100 is connected with the controller 400, and may display an image corresponding to a signal transmitted from the controller 400. The transparent flexible display panel 100 has a characteristic of flexibility, and the end side of one side of the transparent flexible display panel 100 can be bent in a “U” shape.

The transparent flexible display panel 100 of the present embodiment includes a fingerprint recognition sensor 110, which may recognize a user's fingerprint and may send a signal corresponding to the recognized (e.g., recognized and authorized) user's fingerprint to a controller 400. The fingerprint recognition sensor 110 can be formed of a transparent conductive material such as, for example, indium oxide or indium zinc oxide.

After the fingerprint recognition sensor 110 recognizes a user's fingerprint, the credit card may perform a payment function by the controller 400 for a period of time (e.g., only for a predetermined period of time). By doing so, even if a user loses a credit card, a security feature of the credit card can enable the prevention of any unauthorized payment function.

The frame 200 of the present embodiment supports at least one end of the transparent flexible display panel 100, and enables a payment function using a near field communication (NFC). The frame 200 stores information on a whole process related to payment, and includes an IC chip 210 connected with the controller 400, and the IC chip 210 may be activated by the controller 400 and read by a reader for payment, so that the payment may be made. The activation of the IC chip 210 by the controller 400 is performed for a period of time (e.g., only for a predetermined period of time) after an authorized user's fingerprint is recognized by the fingerprint recognition sensor 110.

The frame 200 includes a light emitting part 220, which may emit light of various colors corresponding to the functions that the credit card performs, may be located on one end of the frame 200, and may be connected with the controller 400. The light emitting part 220 receives a signal from the controller 400 and emits light of different colors when the credit card performs a payment function, a call function, and a multimedia driving function, respectively. As a result, a user can see colors corresponding to the functions being performed by the credit card (e.g., in real time). Also, the light emitting part 220 can emit light (e.g., light of predetermined colors) upon the occurrence of a particular event (e.g., when the credit card reaches or exceeds a credit limit or a predetermined amount of payment). Accordingly, a user can passively check how much the user has spent using the credit card for, for example, a month (e.g., during a billing cycle) by recognizing colors of light emitted from the light emitting part 220, thereby enabling the user to avoid overspending with the credit card.

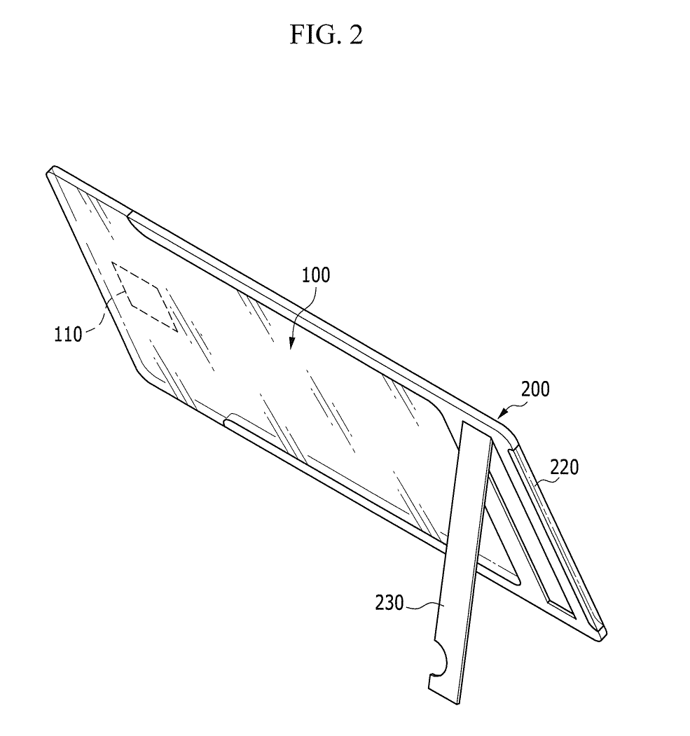

FIG. 2 is a diagram illustrating a back side of the credit card according to the exemplary embodiment of the present invention shown in FIG. 1.

As shown in FIG. 2, the frame 200 of the present embodiment includes a support 230 installed on the back side. The support 230 may be installed on the frame 200 , and may be received by the frame 200. For example, as can be seen in FIG. 2, the frame 200 may have a slot or indentation into which the support 230 may be inserted so that the support 230 may be flush with a surface of the frame 200. The credit card can be supported using the support 230 (e.g., to enable the credit card to stand up). A user can recognize images displayed on the transparent flexible display panel 100 while the credit card is supported by the support 230, for example, when the credit card performs a multimedia driving function.

FIG. 3 is a diagram illustrating a state where the credit card according to the exemplary embodiment of the present invention shown in FIG. 1 is bent.

As shown in FIGS. 1 and 3, the driver 300 is mounted on at least one of the frame 200 and the transparent flexible display panel 100, and the frame 200 bends the transparent flexible display panel 100 so that the end of one side of the transparent flexible display panel is bent in a “U” shape. For example, the driver 300 can be made of bimetal joined with a plurality of conductive materials having different thermal expansion coefficients, and may be installed to support both ends of the transparent flexible display panel 100. Then, the driver 300 is driven (e.g., bent) so that the transparent flexible display panel 100 becomes bent.

The controller 400 is connected with the transparent flexible display panel 100, the fingerprint recognition sensor 110, the IC chip 210, the light emitting part 220, and the driver 300, and controls the transparent flexible display panel 100, the fingerprint recognition sensor 110, the IC chip 210, the light emitting part 220, and the driver 300, respectively. The controller 400 can transmit and receive payment information through a wireless network, and can drive the driver 300 to bend the transparent flexible display panel 100 so that the end side of one side of the transparent flexible display panel 100 is bent in a “U” shape, upon the occurrence of a condition (e.g., when the amount of payment by the credit card exceeds a predetermined limit). Accordingly, when the amount of payment by the payment function of the credit card reaches or exceeds a limit (e.g., exceeds a predetermined limit) and the transparent flexible display panel 100 is bent, a user can be alerted to the risk of, or prevented from, overspending with the credit card by passively checking the payment information notifying that the amount of payment exceeds the predetermined limit.

As mentioned above, in the credit card according to an exemplary embodiment of the present invention, the end side of one side of the transparent flexible display panel 100 is bent in a “U” shape by the controller 400 and the driver 300 when a predetermined limit is exceeded. By doing so, since the credit card actively informs a user that payment with the credit card exceeds a predetermined limit, the user can passively check that the payment with the credit card exceeds the predetermined limit, thereby being prevented from, or warned of, overspending with the credit card.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

Description of Some of the Reference Characters

Transparent flexible display panel 100, Frame 200, Driver 300, Controller 400

What is claimed is:

1. A credit card, comprising:
a transparent flexible display panel for displaying an image;
a frame supporting at least one end of the transparent flexible display panel;
a driver coupled to the frame and configured to bend the transparent flexible display panel; and
a controller coupled to the driver for driving the driver upon an occurrence of a condition,
wherein the credit card is configured to enable a payment function.

2. The credit card of claim 1, wherein the transparent flexible display panel comprises an organic light emitting element.

3. The credit card of claim 1, wherein the transparent flexible display panel comprises a fingerprint recognition sensor for analyzing a fingerprint.

4. The credit card of claim 3, wherein the transparent flexible display panel further comprises an organic light emitting element.

5. The credit card of claim 3, wherein the payment function is enabled only for a period of time after the fingerprint recognition sensor recognizes the fingerprint as authorized.

6. The credit card of claim 5, wherein the transparent flexible display panel comprises an organic light emitting element.

7. The credit card of claim 1, wherein the frame comprises a light emitting part for emitting light of various colors.

8. The credit card of claim 7, wherein the transparent flexible display panel comprises an organic light emitting element.

9. The credit card of claim 1, wherein the frame comprises a support for enabling the credit card to be freestanding.

10. The credit card of claim 9, wherein the transparent flexible display panel comprises an organic light emitting element.

11. The credit card of claim 1, wherein the driver is mounted on a portion of the frame and is configured to bend the transparent flexible display panel so that an end side of the transparent flexible display panel is bent in a “U” shape.

12. The credit card of claim 1, wherein the occurrence of the condition is when a payment amount exceeds a limit.

13. The credit card of claim 1, wherein the payment function uses a near field communication (NFC).

14. The credit card of claim 1, further comprising bimetal coupled to a plurality of conductive materials having different thermal expansion coefficients to enable the driver to bend the transparent flexible display panel.
